(19) United States
(12) Patent Application Publication
(10) Pub. No.: US 2010/0028090 A1
(43) Pub. Date: Feb. 4, 2010

(54) POWDER FEEDING DEVICE OF A POWDER SPRAY COATING APPRATUS WITH SIEVE

(75) Inventors: Felix Mauchle, Abtwil (CH); Mark Steinemann, Hofstetten (CH)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW GEMA AG, St. Gallen (CH)

(21) Appl. No.: 12/523,058

(22) PCT Filed: Jan. 16, 2008
(86) PCT No.: PCT/IB08/00094

§ 371 Date: Jul. 14, 2009

(30) Foreign Application Priority Data
Feb. 2, 2007 (DE) 10 2007 005 306.3

(51) Int. Cl. B65G 53/40

(52) U.S. Cl. 406/121

(57) ABSTRACT

Powder feed device of a powder spraycoating apparatus. A pump is configured in the powder path from a sieve to an intermediate receptacle.

The present invention relates to a powder feeding device, hereafter powder feed device—of a spray coating apparatus, hereafter spraycoating apparatus—defined in the preamble of claim 1.

Spraycoating apparatus fitted with a powder feed device illustratively are known from U.S. Pat. No. 3,918,641 and German patent 42 39 496 A1. In such equipment, coating powder drops by gravity from a sieve into an intermediate receptacle.

The objective of the present invention is to design a more effective powder feed device.

This problem is solved by the features of claim of the present invention.

Accordingly the present invention relates to a spraycoating apparatus' powder feed device containing a sieve to sift a coating powder, said sieve being situated between a powder intake side and a powder outlet side; to an intermediate receptacle comprising a chamber which is connected or connectable—to allow powder flow by means of at least one powder feed conduit—to the sieve's powder outlet side for the purpose of receiving and interim storage of the coating powder sifted through said sieve; characterized in that a powder pump to move the sifted coasting powder into the intermediate receptacle chamber is configured in-line in the path followed by the said powder from the sieve powder outlet side through the minimum of one powder feed conduit(s) to the intermediate receptacle chamber.

The dependent claims of the present invention define further features of this invention.

In the present invention, rapid conveyance of the sifted powder in metered quantities into the intermediate receptacle is made possible by using pumps in the powder feed conduits between the sieve and the intermediate receptacle. Hence the intermediate receptacle no longer must be configured underneath the sieve but may be laterally offset or spaced from said sieve. The sifted powder feed conduits between the two components should be as short as possible. The pumps can be mounted in said conduits or at their upstream or downstream ends, for instance at the sieve or at the intermediate receptacle. The sieve's powder outlet side and/or the powder intake side jointly with flow conduits connected to them may constitute a closed system preventing any powder from leaking into the atmosphere. The powder feed device can be quickly cleaned in short cleaning times, not only as regards monochrome operation but also for multicolor operation requiring frequent changes.

The present invention is described below by means of preferred embodiment modes and in relation to the appended drawings.

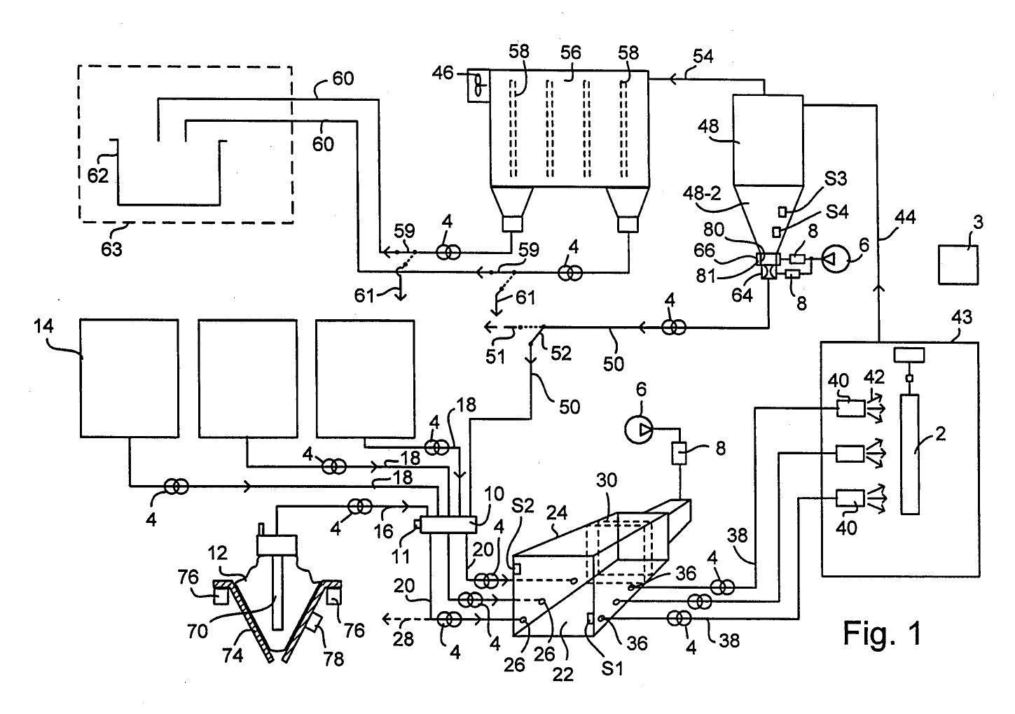

FIG. 1 schematically shows a powder spraycoating apparatus fitted with a powder feed device of the invention,

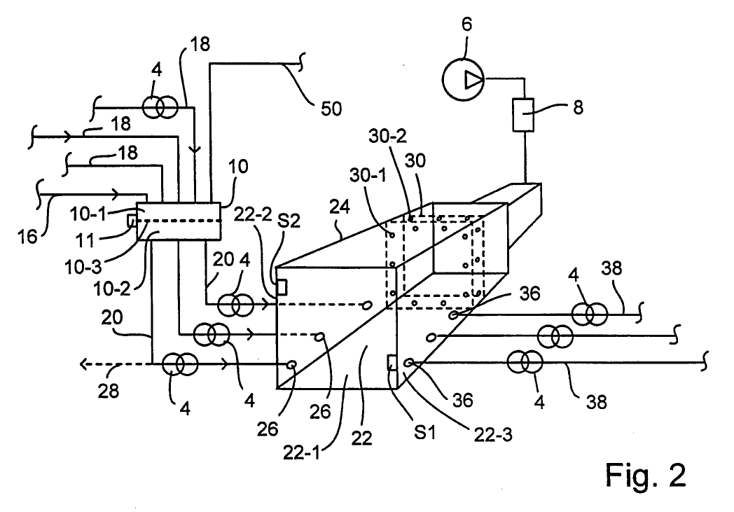

FIG. 2 is a schematic, enlarged view of said device of FIG. 1, and

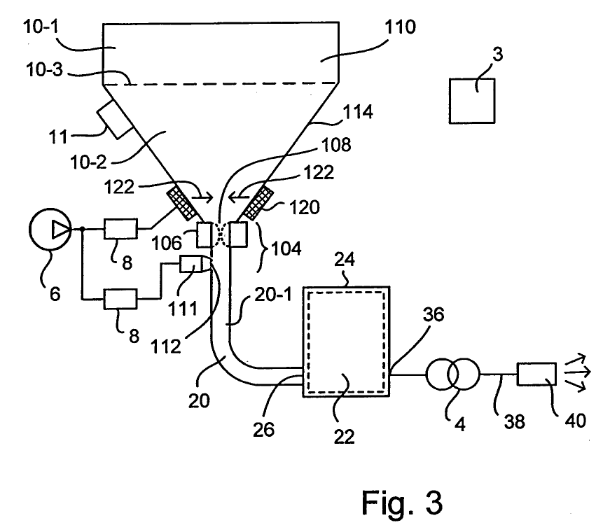

FIG. 3 shows a preferred embodiment mode the invention.

FIG. 1 schematically shows a preferred embodiment of a powder spraycoating apparatus of the invention to spraycoat objects 2 with coating powder—molten in an omitted furnace—onto the object. One or more electronic controls 3 control the operation of the powder spraycoating apparatus. Powder pumps 4 serve to pneumatically move the coating powder. Said pumps may be injectors wherein compressed air acting as the conveying means sucks coating powder out of a powder silo and thereupon the mixture of conveying air and coating powder flows jointly into a container or to a spray device.

Injectors are known for instance from the patent document EP 0 412 289 B1.

The powder pumps being used may be of the kind that consecutively move small powder portions using compressed air, each small powder portion (quantity) being stored in a powder silo and then being expelled from it by compressed air. The compressed air remains behind the powder portion and pushes against the powder in front of it. These kinds of pumps occasionally also are called compressed air thrust pumps or plug moving pumps because the compressed air moves the stored powder portion like a plug in front of it through a pump outlet conduit. Various kinds of such powder pumps moving packed coating powder illustratively are known from DE 103 53 968 A1; U.S. Pat. No. 6,508,610 B2; US 2006/0193704 A1; DE 101 45 448 A1 and WO 2005/051549 A1.

The invention is not restricted to one of the known kinds of pumps.

A source of compressed air 6 is used to generate the compressed air to pneumatically move the coating powder and fluidize it, said source being connected to the various components by corresponding pressure adjusting elements 8 such as pressure regulators and/or valves.

Fresh powder from the manufacturer is fed from a manufacturer's container—which may be a small container 12 for instance a dimensionally stable container or a bag holding for instance 10 to 50 kg powder, for instance 25 kg, or for instance a large container 14 also dimensionally stable or a bag, holding for instance between 100 kg and 1,000 kg powder—by means of a powder pump 4 in a fresh powder conduit 16 or 18 to a sieve 10. The sieve 10 may be fitted with a vibrator 11. Herein the expressions “small container” and “large container” denote both dimensionally stable containers and those which are not, such as flexible bags, unless as otherwise specifically noted.

The coating powder sifted through the sieve 10 is moved by gravity or preferably always by a powder pump 4 through one or more powder feed conduits 20 through powder intake apertures 26 into an intermediate receptacle chamber 22 of a dimensionally stable intermediate receptacle 24. Preferably the volume subtended by the intermediate receptacle 22 is substantially smaller than that of the fresh powder small container 12.

In a preferred embodiment mode of the invention, the powder pump 4 of the minimum of one powder feed conduit 20 leading to the intermediate receptacle 24 is a compressed air pump. In this instance the initial segment of the powder feed conduit 20 may serve as a pump chamber which receives the powder sifted through the sieve 10 as it drops through a valve, for instance a pinch valve. Once this pump chamber contains a given powder portion, the powder feed conduit 20 is shut off from the sieve 10 due to valve closure. Next the powder portion is forced by compressed air through the powder feed conduit 20 into the intermediate receptacle chamber 22.

Preferably the powder intake apertures 26 are configured in a sidewall of the intermediate receptacle 24, preferably near the bottom of the intermediate receptacle chamber 22, so that, when compressed-air flushes the intermediate receptacle chamber 22, even powder residues at the bottom can be expelled through the powder intake apertures 26, and for that purpose the powder feed conduits 20 preferably are separated from the sieve 10 and directed into a waste bin as indicated by a dashed arrow 28 in FIG. 1. The intermediate receptacle chamber 22 is cleaned for instance by a plunger 30 that is fitted with compressed air nozzles and is displaceable through the intermediate receptacle chamber 22.

Powder pumps 4, for instance injectors, are connected to one or more powder outlet apertures 36 to move coating powder through powder conduits 38 to the spray coating apparatus 40. The spray apparatus 40 may be fitted with spray nozzles or rotary atomizers to spray coating powder 42 onto the object 2 to be coated, said object being situated in a coating cabin 43. Preferably the powder outlet apertures 36 are situated in a wall that is opposite the wall containing the powder intake apertures 26. Preferably the powder outlet apertures 36 also are configured near the bottom of the intermediate receptacle chamber 22

Preferably the size of the intermediate receptacle chamber 22 allowing storing coating powder in amounts between 1.0 and 12 kg, preferably between 2.0 and 8.0 kg. In other words, the size of the intermediate receptacle chamber 22 preferably shall be between 500 and 30,000 cm³, preferably between 2,000 and 20,000 cm³. The size of the intermediate receptacle chamber 22 is selected as a function of the number of powder outlet apertures 36 and of powder conduits 38 connected to them in a manner to allow continuous spraycoating while also allowing rapidly cleaning the intermediate receptacle chamber 22 in pauses of operation for purposes of powder changes, preferably in automated manner. The intermediate receptacle chamber 22 may be fitted with a fluidizing means to fluidize the coating powder.

Coating powder 42 failing to adhere to the object 2 is aspirated as excess powder through an excess powder conduit 44 by means of a flow of suction air from a blower 46 into a cyclone separator 48. In the cyclone separator, the excess powder is separated as much as possible from the suction flow. The separated powder proportion is then moved as recovered powder from the cyclone separator 48 through a recovered powder conduit 50 to the sieve 10 and from there it passes through said sieve either by itself or admixed to fresh powder through the powder feed conduits 20 once more into the intermediate receptacle chamber 22.

Depending on the kind of powder and/or the intensity of powder soiling, the powder recovery conduit 50 also may be separated from the sieve 10 and move the recovery powder into a waste bin as schematically indicated by a dashed line 51 in FIG. 1. In order that the powder recovery conduit need not be separated from the sieve 10, it may be fitted with a switch allowing connecting it either to the sieve 10 or to a waste bin.

The intermediate receptacle 24 may be fitted with one or more sensors, for instance two sensors S1 and/or S2 to control feeding coating powder into the intermediate receptacle chamber 22 by means of the control 3 and the powder pumps 4 in the powder feed conduits 20. Illustratively the lower sensor S1 detects a lower powder level limit and the upper sensor S2 detects an upper powder level limit.

The lower end segment 48-2 of the cyclone separator 48 can be designed and used as a recovery powder supply silo and be used as such and be fitted for that purpose with one or several illustratively two sensors S3 and/or S4 which are operationally connected to the control 3. As a result the fresh powder feed through the fresh powder feed conduits 16 and 18 may be stopped, especially in automated manner, until enough recovery powder shall accumulate in the cyclone separator 48 to feed through the sieve 10 enough recovery powder into the intermediate receptacle chamber 22 for spraycoating using the sprayer 40. Once the recovery powder becomes insufficient in the cyclone separator 48 for such operation, the switchover to the fresh powder feed through the fresh powder conduits 16 or 18 may automatically kick in. The invention also offers the possibility to simultaneously feed fresh and recovery powders to the sieve 10 to admix them to one another.

The exhaust air of the cyclone separator 48 passes through an exhaust air conduit 54 into a post filtration system 56 and therein through one or more filter elements 58 to arrive at the blower 46 and beyond latter into the atmosphere. The filter elements 58 may be filter bags or filter cartridges of filter plates or similar elements. Ordinarily the powder separated from the air flow by means of the filter elements 58 usually is waste powder and drops by gravity into a waste bin, or, as shown in FIG. 1 it may be moved by means of one or several waste conduits 60 each fitted with a powder pump 4 into a waste bin 62 at a waste station 63.

Depending on the kind of powder and on the powder coating conditions, the waste powder also may be recovered and moved to the sieve 10 in order to be recirculated into the coating circuit. This feature is schematically indicated in FIG. 1 by switches 59 and branch conduits 61 of the waste conduits 60.

Typically only cyclone separators 48 and the post filtration system 56 are used for multicolor operation, wherein different colors each are sprayed only for a short time, and the waste powder of the post filtration system 56 is moved into the waste bin 62. In general the powder-separating efficiency of the cyclone separator 48 is less than that of the post filtration system 56, but cleaning is more rapid than in the post filtration system 56. As regards monochrome operation, wherein the same powder is used for a long time, the cyclone separator 48 may be dispensed with, and the excess powder conduit 44 instead of the exhaust air conduit 54 may be connected to the post filtration system 56, and the waste conduits 60—which in this instance contain recovery powder—are connected as powder recovery conduits to the sieve 10. Typically the cyclone separator 48 is used in combination with the post filtration system 56 in monochrome operation only when the coating powder entails problems. In such eventuality only the recovery powder of the cyclone separator 48 is moved through the powder recovery conduit 50 to the sieve 10 whereas the waste powder of the post filtration system 56 is moved into the waste bin 62 or into another waste bin, said waste bin being optionally free of waste conduits 60 and directly positioned underneath an outlet aperture of the post filtration system 56.

The lower end of the cyclone equipment 48 may be fitted with an outlet valve 64, for instance a pinch valve. Moreover fluidizing means 66 to fluidize the coating powder may be configured above said outlet valve 64, in or at the lower end segment 48-2, constituted as a supply container of the cyclone separator 48. The fluidizing means 66 contains at least one fluidizing wall 80 made of material comprising open pores or fitted with narrow boreholes, this material passing compressed air but not the coating powder. The fluidizing wall 80 is situated between the powder path and a fluidizing compressed air chamber 81. The fluidizing compressed air chamber 81 may be connected by a compressed air adjusting element 8 to the compressed air source 6.

For the purpose of evacuating by suction fresh coating powder, the fresh powder conduit 16 and/or 18 may be connected to allow powder flow at is upstream end either directly or through the powder pump 4 with a powder moving pipe 70, said pipe being dippable into the manufacturer's container 12 or 14. The powder pump 4 may be mounted at the beginning of, the end of or in-between in the fresh powder conduit 16 or 18 or at the upper or lower end of the powder moving pipe 70.

A small fresh powder container in the form of a fresh powder bag 12 is shown in FIG. 1 held in a bag-receiving hopper 74. The bag-receiving hopper 74 keeps the powder bag 12 in a specified shape, the bag opening being at the upper bag end. The bag-receiving hopper 74 may be mounted on a scale or on weighing sensors 76. These scale or weighing sensors depending on their design may generate visual displays and/or electrical signals that, following subtraction of the weight of the bag-receiving hopper 74, will correspond to the weight and hence the quantity of the coating powder in the small container 12. Preferably a minimum of one vibrator 78 is mounted at the bag-receiving hopper 74 to vibrate it.

Two or more small containers 12 may be configured each in one bag-receiving hopper 74, also two or more large containers 14 operating alternately. This feature allows rapidly changing from one small container 12 to another or one large container 14.

The invention may be modified in a number of ways without restricting it. For instance the sieve 10 may be integrated into the intermediate receptacle 24. Alternatively the sieve 10 may be omitted when the fresh powder quality is high enough. In that case a separate sieve may be used to sift the recovery powder of the conduits 44 and 50, illustratively upstream or downstream of the cyclone separator 48 or in it. Again, sifting the recovery powder will not be required when its quality is adequate for re-use.

In the preferred embodiment mode of FIG. 2, the powder intake apertures 26 are configured in a side wall 22-2 and the powder outlet apertures 36 in another side wall 22-3 of the intermediate receptacle chamber 22. The two side walls 22-2 and 22-3 are spaced apart and opposite to each other and bound a chamber bottom 22-1.

In other embodiment modes of the invention, the powder intake apertures 26 and/or the powder outlet apertures 36 may be configured in the chamber bottom and/or in the chamber ceiling and/or all of them in the same chamber wall, in the chamber bottom or in the chamber ceiling.

As shown by FIG. 2, the plunger 30—which is displaceable in reciprocating manner in the intermediate receptacle chamber 22—is fitted with compressed air nozzles 30-1 and 30-2 to blow compressed air against the bounding surfaces of the intermediate receptacle chamber 22. Preferably the compressed air nozzles 30-1 and 30-2 are configured on the front side of the plunger 30 near its periphery and/or at its periphery and point into the intermediate receptacle chamber 22 in FIG. 2.

The powder pumps 4 in the powder feed conduits 20 allow that the sieve 10 and the intermediate receptacle 24 be configured at appropriate distances and also laterally apart from each other. Furthermore the partial vacuum produced by these powder pumps 4 precludes coating powder from escaping from the sieve 10 into the atmosphere.

The powder feed conduits 20, the powder outlet side 10-2 of the sieve 10 and the intermediate receptacle chamber 22 together may constitute a closed system or may be closed in a manner that coating powder cannot escape from them into the atmosphere.

The powder intake side 10-1 of the sieve 10 and the powder feed devices 4, 12, 16 and/or 4, 14, 18 and/or 4, 48, 50 connected to said intake side and sieve may be configured as a closed system in a manner that no coating powder can escape from them into the atmosphere.

The sieve element 10-3 of the sieve 10 is situated between its powder intake side 10-1 and its powder outlet side 10-2. The vibrator 11 shakes the sieve element 10-3.

FIG. 3 shows a preferred embodiment mode of the invention. This embodiment provides a sieve 110 instead of the sieve 10, the sieve 110 in this case being fitted with a sieve element 10-3 between an upper powder intake side 10-1 and a lower outlet side 10-2. Moreover a vibrator 11 to shake the sieve element 10-3 may be provided. The feature of FIG. 3 is that the powder pump 104—which is situated in the powder feed conduit 20 from the powder outlet side 10-2 of the sieve 110 to a powder intake side 26 of the intermediate receptacle chamber 22 of the intermediate receptacle 24—is a compressed air thrust pump 104. Another feature of this embodiment preferably is that the upstream beginning section 20-1 of the powder feed conduit 20 is used as the pump chamber of the powder pump 104. The upstream beginning segment 20-1 of the powder feed line 20 preferably runs vertically upward and communicates through a valve 106, preferably a pinch valve, with a downwardly pointing powder outlet 108. The communication between the powder outlet 108 of the powder outlet side 10-2 and the upstream beginning segment 20-1 of the powder feed conduit 20 can be open or interrupted by opening or closing the valve 106. Also the powder pump 104 contains a conveying air feed device 111 fitted with at least one conveying air intake aperture 112 which issues in the beginning segment 20-1 of the powder feed conduit 20 that acts as the pump chamber. The conveying air feed device 111 can be connected by at least one control element 8, such as a further valve and optionally a pressure regulator, to the compressed air source 6, driven by the control 3 also driving the valve 106 of the powder pump 104.

When the valve 106 of the powder pump 104 is open, sifted coating powder drops from the powder outlet side 10-2 through the powder outlet 108 and the valve 106 into the beginning segment 20-1—of the powder feed conduit 20—acting as the pump chamber. Because of the narrow conduit cross-section and/or a sideways arc of the powder feed conduit 20, the coating powder accumulates in this conduit. Next the valve 106 of the powder pump 104 is closed. Once the valve 106 is closed, compressed air acting as conveying air is introduced by the conveying air feed 111 through the conveying air intake 112 into the beginning segment 20-1 of the powder feed conduit 20 acting as pump chamber, as a result of which this compressed air moves the powder portion (quantity of powder) collected in the powder feed conduit 20 through the powder feed conduit 20 into the intermediate receptacle chamber 22 of the intermediate receptacle 24. Thereupon the feed of compressed air from conveying air feed 111 is shut off again by the associated control element 8 by means of the control 3, whereupon the valve 106 of the powder pump 104 is reopened.

Over at least part of its height, the housing of the sieve 10 at the powder outlet side 10-2 is like a hopper, the powder passing cross-section being reduced from the size of the sieve element 10-1 to the diameter of the powder outlet aperture 108. The hopper-shaped housing wall is denoted by 114 in FIG. 3. Preferably at the lower end of the hopper-like housing wall 114, the powder outlet side 10-2 is fitted with a fluidizing means 120 to introduce fluidizing compressed air 122 into the lower end of the powder outlet side 10-2 to fluidize the coating powder above the valve 106 of the powder pump 104.

1. A powder feed device of a powder spraycoating apparatus containing: a sieve to sift coating powder through a sieve element between a powder intake side and a powder outlet side; an intermediate receptacle comprising an intermediate receptacle chamber connected or connectable to allow powder flow by at least one powder feed conduit to the powder outlet side of the sieve to receive and act as interim storage for the coating powder sifted by said sieve
characterized in that
a powder pump (4; 104) to move the sifted coating powder into the intermediate receptacle chamber (is configured in the powder path from the powder outlet side of the sieve through the minimum of one powder feed conduit to the intermediate receptacle chamber.

2. Powder feed device as claimed in claim 1, characterized in that the intermediate receptacle his fitted in a receptacle bottom or in a receptacle side wall of the intermediate receptacle chamber with at least one powder intake aperture which is connected to one of the minimum of one powder feed conduits.

3. Powder feed device as claimed in claim 1, characterized in that the intermediate receptacle his fitted in a receptacle bottom or in a receptacle side wall near the receptacle bottom of the intermediate receptacle chamber with at least one powder outlet aperture to dispense coating powder from the intermediate receptacle chambers.

4. Powder feed device as claimed in claim 3, characterized in that the receptacle side wall containing the minimum of one powder outlet aperture is configured at a space apart oppositely the receptacle wall containing the minimum of one powder intake aperture.

5. Powder feed device as claimed in claim 3, characterized in that at least one powder pump is connected to the minimum of one powder outlet aperture.

6. Powder feed device as claimed in claim 1, characterized in that the intermediate receptacle chamber (subtends a storage volume in the range of 500 to 30,000 cm³, preferably between 2,000 and 20,000 cm³.

7. Powder feed device as claimed in claim 1, characterized in that the intermediate receptacle comprises an automated cleaning system which is fitted with a plunger which cleans the intermediate receptacle chamber and which can be reciprocated through said chamber, further with compressed air nozzles to blow compressed air against the bounding surfaces of said chamber, these compressed air nozzles preferably being configured on the front side of the plunger and pointing toward the intermediate receptacle chamber (while configured near said plunger's outer periphery and/or at its periphery.

8. Powder feed device as claimed in claim 1, characterized in that the intermediate receptacle is laterally offset from the sieve.

9. Powder feed device as claimed in claim 1, characterized in that the powder outlet side of the sieve is connected or connectable by two or more powder feed conduits to the intermediate receptacle chamber to allow powder flow, and in that a powder pump is configured in the powder path of each of the minimum of one powder feed conduit.

10. Powder feed device as claimed in claim 1, characterized in that the powder pump always is an injector operating on the jet pump principle or a pump of the kind aspirating metered quantities of powder which then are expelled by compressed air through a powder outlet.

11. Powder feed device as claimed in claim 1, characterized in that the sieve is fitted with at least one vibrator to shake the sieve element.

12. Power feed device as claimed in claim 1, characterized in that for the purpose of automated powder feed to the powder intake side of the sieve, at least one powder feed device is connected or connectable to the powder intake side of the sieve.

13. Powder feed device as claimed in claim 11, characterized in that at least one of the minimum of one powder feed devices is a powder recovery system to recover and re-use excess sprayed powder.

14. Powder feed device as claimed in claim 12, characterized in that at least one of the minimum of one powder feed device is a fresh-powder feed device to dispense fresh powder from a fresh powder container.

15. Powder feed device as claimed in claim 14, characterized in that the powder receiving volume of the intermediate receptacle chamber of the intermediate receptacle is less than the powder receiving volume of the fresh powder container, preferably being 50% or less or only 25% or less.

16. Powder feed device as claimed in claim 1, characterized in that the powder feed conduits, the powder outlet side of the sieve and the intermediate receptacle chamber (together constitute a closed system or can be closed in such manner that coating powder is precluded from escaping from them into the atmosphere.

17. Powder feed device as claimed in claim 1, characterized in that the powder intake side of the sieve and the powder feed devices connected to it are configured as a closed system in a manner that no coating powder can escape from them into the atmosphere.

18. Powder feed device as claimed in claim 1, characterized in that the powder pump of the powder feed conduit is a compressed air thrust pump comprising at least one pump chamber to store in each case one powder portion, further a controlled valve at a powder intake of the powder chamber and a conveying air feed system to introduce compressed air into said pump chamber and in the process expelling the powder portion by means of the introduced compressed air out of the pump chamber and through the powder feed conduit.

19. Powder feed device as claimed in claim 18, characterized in that the powder chamber is constituted by an upstream beginning segment of the powder feed conduit.
